(19) United States
(12) Patent Application Publication
(10) Pub. No.: US 2004/0261171 A1
(43) Pub. Date: Dec. 30, 2004

(54) Double pulsating hydrotherapy jet

(75) Inventors: Michael D. Holtsnider, Moorpark, CA (US); Raymundo Colin, Simi Valley, CA (US)

Correspondence Address: Robert T. Conley, KOPPEL, JACOBS, PATRICK & HEYBL, Suite 107, 555 St. Charles Drive, Thousand Oaks, CA, 91360, US

(73) Assignee: B & S PLASTICS, INC. dba WATERWAY PLASTICS

(21) Appl. No.: 10/611,475

(22) Filed: Jun. 30, 2003

(51) Int. Cl. A61H 33/04

(52) U.S. Cl. 4/541.6

(57) ABSTRACT

A pulsating hydrotherapy jet is disclosed which has a jet body with a water inlet to allow water to flow into the body. The jet body discharges the water through a discharge member in more than one concentric pattern. A cap mounted on the body to receive the circular water patterns is also disclosed. The cap has a number of openings that form more than one concentric opening ring. Each of the opening rings align with a respective one of the circular water patterns to provide the sensation of a number of circular patterns of multiple pulsating jets. A system for providing a hydrotherapy jet to a reservoir of water is also disclosed. The system includes a reservoir shell capable of holding water with a number of hydrotherapy jets according to the invention that are mounted around the reservoir shell. A water pump system circulates water from the reservoir to the jets.

### BACKGROUND OF THE INVENTION

1. Field of the Invention

This invention relates to hydrotherapy jets.

2. Description of the Related Art

Various hydrotherapy jets have been developed for use in spas, hot tubs, pools and bath tubs that discharge a stream of water that can be aerated through a variety of discharge nozzles. Designs of these hydrotherapy jets provide different flow characteristics that result in different massage effects being experienced by the body. Such jets have been found to produce a pleasing massage effect for many users, and have become quite popular. In the design of single or multi-use spas or tubs, it is common to use a variety of different jet nozzles to provide a variety of different massaging effects.

Early jets simply discharged a stream of warm water along the longitudinal axis of the jet body, with later jets providing aeration of the water stream. Since then numerous jets have been developed in which the direction of the stream can be adjusted. For example, U.S. Pat. No. 5,269,029 to Spears, et al. (assigned to the same assignee as the present invention) discloses a jet that provides an off axis stream of water and has an axial push-pull mechanism used to control the flow of water. The mechanism can also be rotated to rotate a stream of water around the jet axis, thus providing directional control over the stream.

Jets have also been developed having a rotating outlet or eyeball that automatically rotates in response to water flowing through the outlet. As an example, see Waterway Plastics, Inc., “1999 product catalog,” page 4, including part nos. 210-6120 and 210-6510. In these jets, the outlet can be adjusted off the jet's longitudinal axis to provide a turning moment in the eyeball in response to the water stream flow.

U.S. Pat. No. 6,178,570 to Denst et al. (assigned to the same assignee as the present invention) discloses a jet having a rotating eyeball with one or more discharge outlets that can be adjusted to vary the direction of the outlet flow stream, as well as the direction and speed of the eyeball's rotation. A high-pressure water stream flows through the outlets and, depending on the orientation of the outlets, the eyeball can rotate clockwise or counter-clockwise at different speeds.

U.S. Pat. No. 5,920,925 to Dongo (assigned to the same assignee as the present invention) discloses a jet having a rotating eyeball and a cap formed with a number of openings positioned at a common radius from the center of the cap. The jet produces a high-pressure water stream that flows through the eyeball, causing it to rotate at a high speed and discharge the jet in a circular pattern that impinges on the openings. Together, the rotational speed and the opening design produce the sensation of a number of simultaneously pulsating water streams that are directed into the spa.

Various hydrotherapy jets have been developed in the past for use with spas, hot tubs, and bath tubs that discharge an aerated stream of water through a variety of discharge nozzles. In general, such jets produce a constant flow stream that provides a good therapeutic effect. However, in an attempt to enhance the therapeutic effect, several systems have been designed that produce a pulsating flow. These systems have met with varying degrees of success as they often require additional or larger components, which increase system cost and add complexity, or generate unwanted pressure losses, thus requiring a larger pump than would otherwise be required.

One prior art approach has been to use mechanical devices to pulse water flowing to an individual jet, or a series of jets. An example of such a system is described in U.S. Pat. No. 4,320,541 to John S. Neenan. In this approach a series of mechanical blocking devices are used to intermittently block and unblock a flow stream. As a flow stream is unblocked, a pulse of water is sent to the jet and ultimately to the user. While this approach does provide a pulsating effect, blocking and unblocking of the flow stream causes abrupt pressure increases imposing a strain on spa systems. Aside from these drawbacks, such systems require additional components that add complexity, cost and weight. In addition, since the pulsation effect is generated away from the jet, the pulsed flow stream experiences a pressure loss, resulting in a decreased pulsation effect being felt at the jet exit.

In an alternate approach, rather than using mechanical devices to generate a pulsed flow, a hydraulic pumping device is used. In such a system, pulsation is produced by a distribution valve which houses a rotor that is rotated by inlet water flow, and distributes the inlet water to a series of outlets which are connected into the individual jets. The rotor is formed with a groove that sequentially aligns the water outlets to the water inlet so that each outlet is periodically connected to, and then disconnected from, the inlet. The water is supplied into each jet in a pulsating or chopping manner. Examples of this system are given in the U.S. Pat. Nos. 5,444,879 and 5,457,825 to Michael D. Holtsnider and assigned to Waterway Plastics, Inc. the assignee of the present invention.

While hydraulic systems do provide a degree of pulsation, they too suffer from many of the same problems as mechanical systems. For example, as the pulsation effect is generated away from the jet, the pulsed flow stream experiences a pressure loss which results in a reduced pulsation effect at the jet, and like the mechanical systems the additional componentry adds complexity, cost and weight to the system. Also, a larger water pump may be required to provide additional energy to rotate the rotor and to compensate for additional pressure losses.

To overcome the drawbacks associated with mechanical and hydraulic pulsed systems, pulsation systems have been designed that do not require mechanical devices or hydraulic distribution systems. Such systems generally have individual pulsation mechanisms located within the individual jets. Examples are shown in the Waterway “1997 product catalog,” page 1, deluxe and octagon series pulsating jet, and in U.S. Pat. No. 5,657,496 to Corb et al., also assigned to Waterway Plastics, Inc. The individual jets contain rotational devices commonly called eyeballs. The eyeballs have water conduits which discharge water flowing through the jet into the spa or tub. The conduits are angled to cause the eyeball to rotate and distribute the flow stream in a circular pattern. The circular distribution provides, to some degree, the sensation of a pulsed flow as the flow stream interacts with a specific point on the body in a periodic fashion. However, this is not truly a pulsed flow since the user actually experiences a continual flow stream, but in a circular pattern.

Attempts have been made to produce a jet that would produce a true pulsed flow. To this end, several designs have been developed in which pulsation is created at the jet itself. In these systems the flow stream at the jet is blocked periodically to create the sensation of a pulsed flow. See Waterway Plastics, Inc. “1997 product catalog” page 1, Standard Poly jets whirly and pulsator jets, and U.S. Pat. No. 4,508,665 to Spinnett. While both the Waterway and Spinnett Jet designs do in fact produce a pulsed flow, the pulsating is created by blocking the flow stream exiting the discharge member as it rotates past a blocking member. When the flow stream comes in contact with the blocking member the flow is temporarily interrupted or halted, thus generating a pulsed flow that is circular or spiral in nature, moving from one zone to another in a sequential manner. The blocking, however, creates an undesirable backflow into the jet, causing strain on the spa system and ultimately lowering efficiency. In addition, the Spinnett design requires multiple deflections of the flow stream as it passes through the jet, causing pressure losses and lowering the system efficiency.

### SUMMARY OF THE INVENTION

The invention includes a jet, a rotating discharge member and a cap formed with a number of openings positioned at different distances from the center of the cap. The jet produces a high-pressure water stream that flows through the discharge member, causing the discharge member to rotate, and discharge the jet in a number of concentric patterns that impinge on the openings. The openings are formed in the cap so that the upstream intersection of the openings forms a series of ridges that divert the rotating water stream into the appropriate opening(s) without blocking it, or producing a backflow, and are aligned with the rotating discharge member to minimize pressure losses. Together the rotation speed and the opening design produce the sensation of a number of concentric rings each having multiple pulsating water streams that are directed into the spa or tub.

### BRIEF DESCRIPTION OF THE DRAWINGS

These and other further features and advantages of the invention will be apparent to those skilled in the art from the following detailed description, taken together with the accompanying drawings, in which:

FIG. 1 is a simplified exploded perspective view of a pulsating hydrotherapy jet unit in accordance with the invention;

FIG. 2 is a sectional view taken along section line 2-2 of the double pulsating hydrotherapy jet unit of FIG. 9;

FIG. 3 is a top plan view of the discharge member used in the jet of FIG. 1;

FIG. 4 is a sectional view taken along section line 4-4 of the discharge member of FIG. 3;

FIG. 5 is a perspective view of a fully assembled double pulsating hydrotherapy jet unit;

FIG. 6 is a front elevation view of the cap used in the jet of FIG. 5;

FIG. 7 is a sectional view taken along section line 7-7 of the cap of FIG. 6;

FIG. 8 is a sectional view taken along section line 8-8 of the cap of FIG. 6;

FIG. 9 is a front elevation view of an assembled double pulsating hydrotherapy jet unit;

FIG. 10 is a top plan view of one embodiment of the cap used in the jet of FIG. 2;

FIG. 10a is a bottom plan view of one embodiment of the cap used in the jet of FIG. 2

FIG. 11 is a sectional view of one embodiment of the discharge member used in the jet of FIG. 2;

FIG. 12 is an exploded perspective view of a double pulsating hydrotherapy jet unit of FIG. 9;

FIG. 13 is a perspective view of a spa/tub system using the present invention; and

FIG. 14 is a flowchart demonstrating one embodiment of the claims.

### DETAILED DESCRIPTION OF THE INVENTION

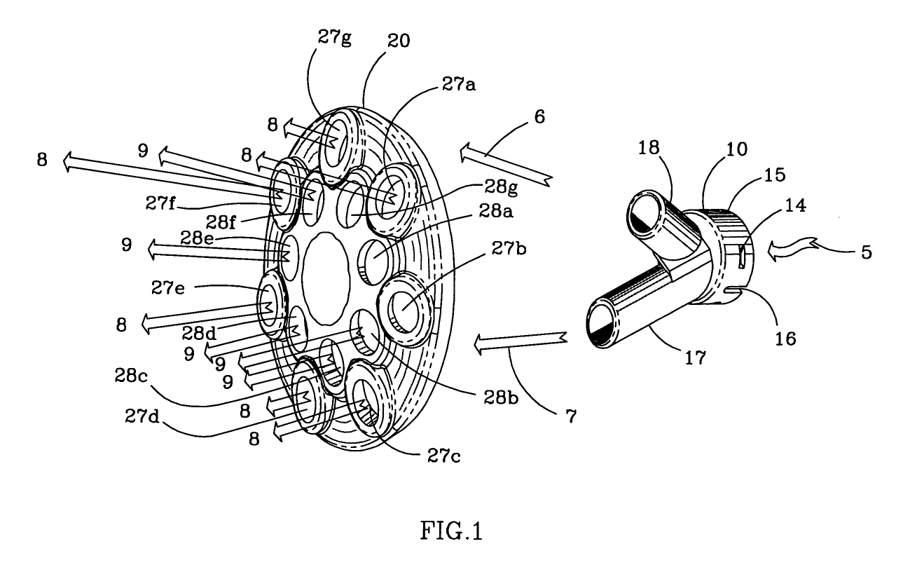

The invention, as shown in FIG. 1, relates to a low-pressure loss hydrotherapy jet system 40 that uses a single water supply 3 (not shown) and a single air intake 4 (not shown) to produce multiple concentric rings of multiple simultaneously pulsating jets in a spa bath. As shown in FIG. 1 aerated water stream 5 enters discharge member 10, which has a major outlet conduit 17 and a minor outlet conduit 18. Jet 5 enters discharge member 10 and splits into jets 6 and 7, which exit discharge member 10 through minor outlet conduit 18 and major outlet conduit 17 respectively. Jets 6 and 7 discharge in concentric patterns from discharge member 10. These concentric pattern jets 6 and 7 impinge a series of rings of openings 28a-28g and 27a-27g respectively molded within a stationary cap 20. Jet 7 passing through openings 27a-27g generates a ring of major pulsating jets 8. Jet 6 passing through openings 28a-28g generates a ring of minor pulsating jets 9.

In one embodiment the upstream intersection of the openings create a ridge that diverts the rotating jet to the respective openings without generating substantial back flow. In one embodiment, when discharge member 10 receives a water supply having a pressure of at least 10 pounds per square inch (psi), discharge member 10 rotates fast enough that the user may have the sensation of major and minor jets 8 and 9 pulsating simultaneously. Simultaneous jets 9 may appear to be concentric with simultaneous jets 8. In one embodiment discharge member 10 may rotate at speeds of at least 500 revolutions per minute (rpm). In one embodiment, the system has the added advantage that its design results in lower pressure losses.

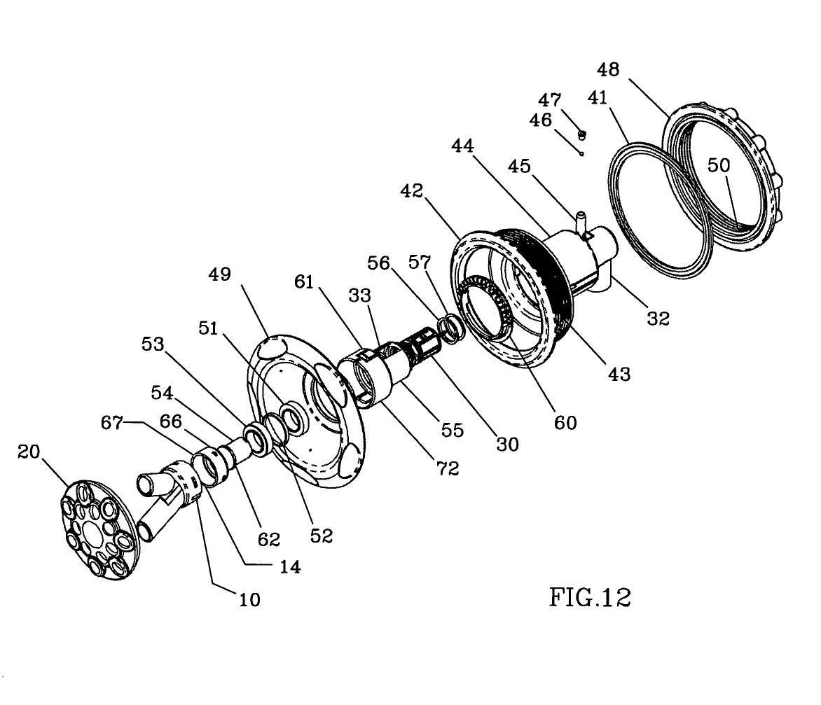

FIG. 1 also shows discharge member 10 has a discharge member sleeve 15 that connects to inner discharge member sleeve 67 (shown in FIG. 12). Locking slot 14 on discharge member sleeve 15 allows sleeve attachment tab 66 (shown in FIG. 12) to connect inner discharge member sleeve 67 to discharge member 10. Alignment slot 16 allows alignment of discharge member 10 to inner discharge member sleeve 67.

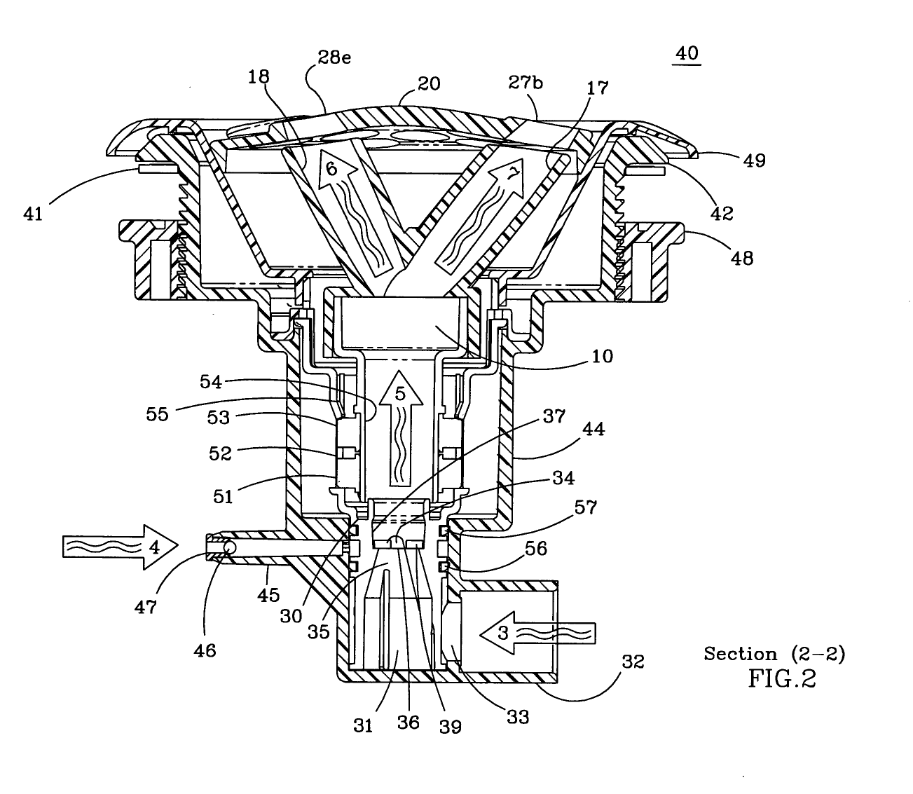

As shown in FIG. 2 major outlet conduit 17 diverts aerated water stream 5 away from the longitudinal axis of water stream 5, and forms discharge stream 7. In one embodiment, discharge stream 7 may impart a rotational moment to discharge member 10. Minor outlet conduit 18 also deflects aerated water stream 5 away from its longitudinal axis forming discharge stream 6, but does not divert it as far away as major outlet conduit 17. In one embodiment, minor discharge stream 6 may impart a rotational moment to discharge member 10.

Channel 31, in FIG. 2, receives water supply 3 flowing from conduit 32 through exit port 33. Exit port 33, whose axis is normal to that of Channel 31, constricts the flow of water supply 3 and provides it to conduit 32. Attached to exit port 33, at its upstream end, is a water jet 30 that houses a venturi 34. Jet 30 is used to produce a high-pressure water stream for the system. Venturi 34 has an upstream section 35 that tapers down to its smallest diameter at throat 36. At throat 36, venturi 34 expands in diameter forming an aft section 37. Air intake 4 enters through air conduit 45. Aft of throat 36, in section 37, are located a series of air openings 39 used to entrain air supply 4 to aerate the water flowing through venturi 34. In this manner, air intake 4 is entrained into water supply 3 forming aerated water stream 5.

In one embodiment, as shown in FIG. 2, major outlet conduit 17 diverts part of aerated water stream 5 into diverted major outlet conduit aerated water stream 7. Diverted major outlet conduit aerated water stream 7 leaves discharge member 10 through major outlet conduit 17. Minor outlet conduit 18 diverts part of aerated water stream 5 into diverted minor outlet conduit aerated water stream 6. Diverted minor outlet conduit aerated water stream 6 leaves discharge member 10 through minor outlet conduit 18. Major and minor aerated flow streams 7 and 6 exiting discharge member 10 thru major outlet conduit 17 and minor outlet conduit 18 respectively encounter openings 27a-27g and 28a-28g respectively. In FIG. 2, aerated water stream 5 exits discharge member 10 as major simultaneously pulsating jet 7 thru major ring opening 27b, and minor simultaneously pulsating jet 6 thru minor ring opening 28e.

Discharge member 10 can be seen just up stream of cap 20. The cross section of major opening 27b may be seen in cap 20. A cross section of minor opening 28e may also be seen in cap 20. FIG. 2 shows major outlet conduit 17 lining up with major ring opening 27b allowing major outlet conduit aerated water stream 7 to exit double pulsating hydrotherapy jet unit 40. FIG. 2 also shows minor outlet conduit 18 aligning up with minor ring opening 28e permitting minor outlet conduit aerated water stream 6 to exit double pulsating hydrotherapy jet unit 40.

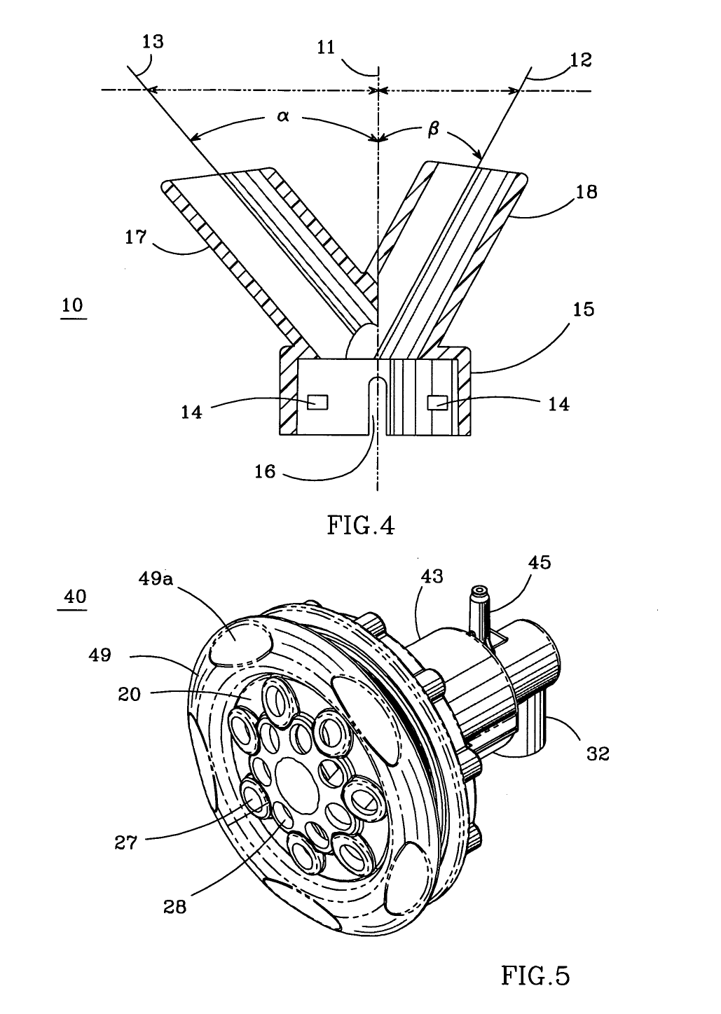

Washer 52 separates bearing rakes 53 and 51 in FIG. 2 from each other. Bearing rakes 53 and 51 permit discharge member 10 to rotate freely around rotational axis 11 as shown in FIG. 4. These bearing rakes 53 and 51 fit over inner bearing sleeve 54 and are attached thereto. The combination of inner bearing sleeve 54, bearings 53 and 51 and washer 52 are then snugly fit inside outer bearing sleeve 55 as is also shown in FIG. 12. The positioning of bearing rake 51 and bearing rake 53 outside bearing sleeve 54 keeps the bearings separate from aerated water stream 5, reducing the chance that over time these bearings might seize. Additionally, having two bearing rakes 51 and 53 reduces the wear that would be encountered by a single bearing rake, thus extending the life of the jet.

Washers 56 and 57, as shown in FIG. 2, confine air uptake 4 entering thru air conduit 45 allowing it to aerate water stream 3 producing aerated water stream 5. Conduit 45 has a check valve comprising check valve ball 46 and check valve ball retainer 47. The check valve prevents water from escaping double pulsating hydrotherapy jet unit 40 back thru air conduit 45. When water enters air conduit 45 check ball 46 is forced against check ball retainer 47 sealing the conduit closed.

As discharge member 10 rotates around its longitudinal axis, major outlet conduit 17 sweeps consecutively through major openings 27a to 27g. As major outlet conduit 17 sweeps through an opening 27a-27g in cap 20, diverted aerated water stream 7 passes through said opening creating a pulse of aerated water stream 8 (shown in FIG. 1).

As discharge member 10 rotates around its longitudinal axis, minor outlet conduit 18 sweeps consecutively through minor openings 28a-28g. As minor outlet conduit 18 sweeps through an opening 28a-28g in cap 20, diverted aerated water stream 6 passes through said opening creating a pulse of aerated water stream 9 (shown in FIG. 1).

As may be seen in FIG. 2, in one embodiment major opening 27b may be aligned with major outlet conduit 17, and thus does not substantially impede the flow of water stream 7 through major outlet conduit 17. In one embodiment, all openings 27a-27g may be aligned with major outlet conduit 17 as opening 27b is shown here. In one embodiment minor opening 28e may be aligned with minor outlet conduit 18, and thus opening 28e does not interfere substantially with the flow of water out of minor outlet conduit 18. In one embodiment, all openings 28a-28g may be aligned with minor outlet conduit 18 as opening 28e is shown here.

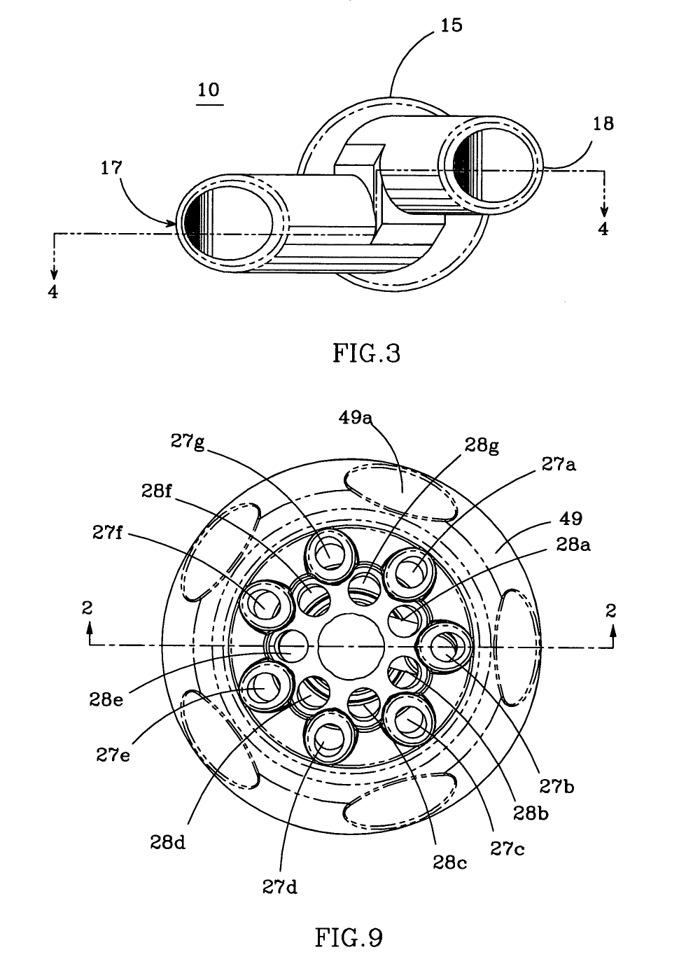

In one embodiment, as shown in FIG. 3 major outlet conduit 17 extends further away from the center axis 11 (shown in FIG. 4) of discharge member 10 then does minor outlet conduit 18.

FIG. 4 shows discharge member 10 has an axis of rotation 11 that is collocated with the longitudinal axis of aerated jet 5 (shown in FIG. 2). FIG. 4 further demonstrates major outlet conduit 17 extending further away from the centerline then does minor outlet conduit 18. In one embodiment, conduits 17 and 18 extend up and out from discharge member 10 in a manner that suggests asymmetric bunny ears.

In one embodiment discharge member 10 has a rotational axis 11 with the two linear water outlet conduits 17 and 18 passing through it. Major outlet conduit 17 has a longitudinal axis 13 that is coplanar with axis 11. Minor outlet conduit 18 has a longitudinal axis 12 that is coplanar with axis 11. Major outlet conduit's 17 longitudinal axis 13, and minor outlet conduit's 18 longitudinal axis 12 are orientated at angles α and β respectively to axis 11 of discharge member 10. In one embodiment α may be greater than 37 degrees, and β may be greater than 21 degrees. Axes 12 and 13 are further offset by an angle γ (not shown) to from a non-intersecting orientation to rotational axis 11 to provide a turning moment to discharge member 10 in response to a jet flow. Jet flows 6 and 7 exiting rotational member 10 trace out concentric patterns, as discharge member 10 rotates, which may be perceived as solid rings of water. In one embodiment angle γ may be approximately 6 degrees.

In one embodiment as shown in FIGS. 2, 3 and 4 major water outlet conduit 17 and minor water outlet conduit 18 pass through and extend downstream from discharge member 10, and are spaced approximately 180 degrees apart from one another about axis 11. Angles α, β and γ are set such that discharge member 10 obtains sufficient rotational speed to provide what may be perceived to be multiple continuous solid concentric bands of water. Interaction of the water bands with cap 20 ultimately may provide the user with the sensation of multiple concentric simultaneously pulsating water streams.

FIG. 5 shows double pulsating hydrotherapy jet unit 40. Cap 20 may be placed within rotating scallop plate 49. Scallops 49a on rotating scallop plate 49 allow the reduction of the flow of water supply 3 to double pulsating hydrotherapy jet unit 40 by rotating discharge member carrier 55 to occlude a portion of water conduit 32 as shown in FIG. 2.

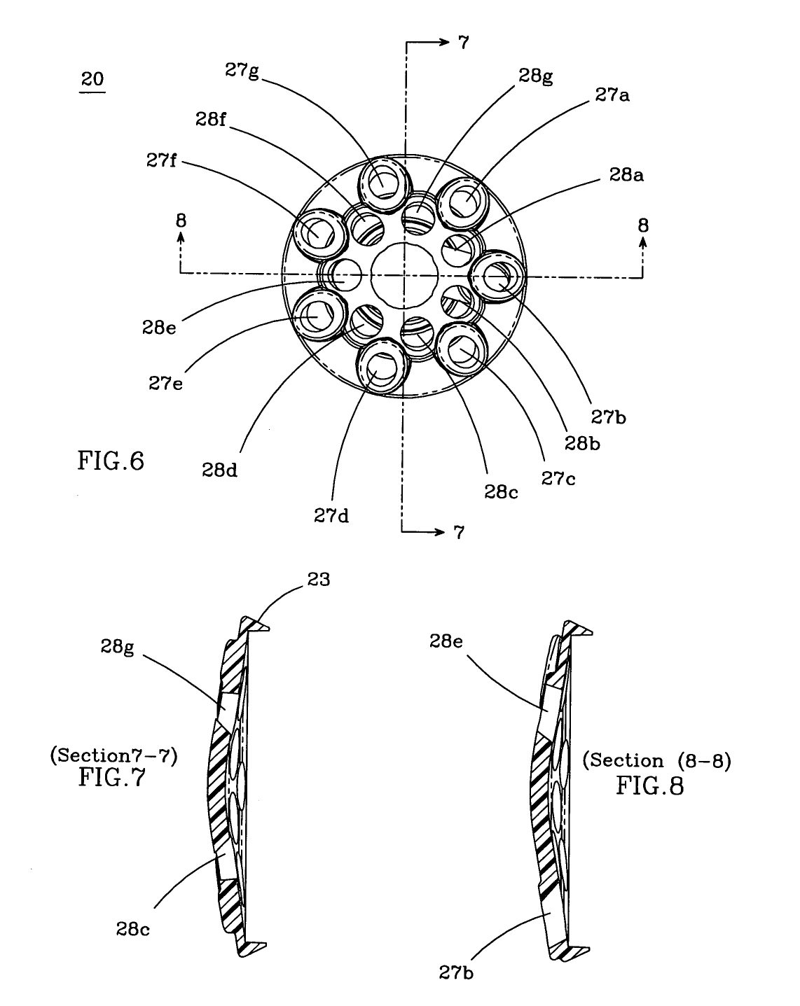

In one embodiment, as shown in FIG. 6, cap 20 contains two series of 7 cylindrical openings 27a-27g and 28a-28g. Cap 20 has major ring openings 27a-27g arrayed around the edge of cap 20 at a common radial distance from the center, or longitudinal axis of cap 20 that coincides with longitudinal axis 11 of discharge member 10 when assembled, i.e. in a circle. Also cap 20 has arrayed around its center a circle of minor ring openings 28a-28g that are arrayed at a common radial distance from the longitudinal axis of cap 20. In one embodiment the radius of major ring openings 27a-27g may be greater than the radius of minor ring openings 28a-28g.

FIG. 7 shows the curve of cap 20, and cap edge ridge 23. Cap edge ridge 23 assists in securing cap 20 within scallop ring 49. This cross section of cap 20 partially exposes minor ring openings 28e and 28g.

FIG. 8 cuts directly through the center of major opening 27b and minor opening 28e. This specific arrangement of openings is one embodiment of a cap for a double pulsating hydrotherapy jet unit 40. Other embodiments will be equally effective in providing the double pulsating hydrotherapy jet effect.

FIG. 9 shows an assembled double pulsating hydrotherapy jet unit 40 showing cap 20 and rotating scallop ring 49. Scallops 49a can be seen around the periphery of rotating scallop ring 49. Scallops 49a allow better finger grip while rotating scallop ring 49 to adjust the rate of flow of water supply 3. Major ring openings 27a-27g may be seen just inside rotating scallop ring 49. Cap 20 on which major ring openings 27a-27g are placed is in fact placed over and nestled within rotating scallop plate 49. In one embodiment, minor ring openings 28a-28g may be seen nested inside and between major ring openings 27a-27g.

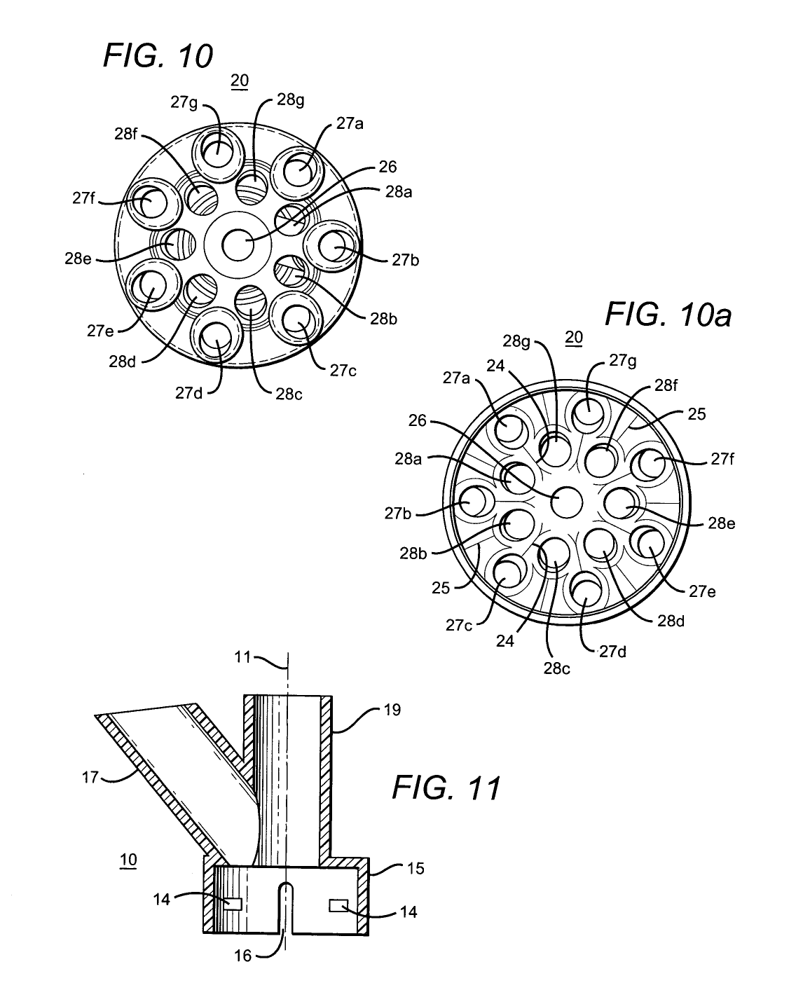

In one embodiment, shown in FIG. 10, cap 20 may have an opening 26 in its center. Center opening 26 may be used to allow discharge of centralized water outlet conduit 19 of FIG. 11.

As is shown in FIG. 10a, upstream of openings 27a through 27g at the intersection of the openings are a series of ridges 25 forming a knife like edge between the openings. The ridges divert water provided from conduit 17 into one or more of openings 27a through 27g. The knife like edge acts to cut the water, diverting it into the openings. The cutting action allows the water to flow into openings without producing back flow as would be the case if the surfaces were flat. Similar ridges 24 may be seen at the intersection of openings 28a through 28g forming a knife like edge between the openings. These ridges divert water provided from conduit 18 into one or more of bore holes 28a through 28g, thus reducing backflow similar to ridges 24.

In one embodiment, as shown in FIG. 11 discharge member 10 may contain a centralized water conduit 19 coaxial with the longitudinal axis 11 of discharge member 10. The centralized water conduit provides a continuous nonpulsating jet to the user in addition to the series of pulsating jets.

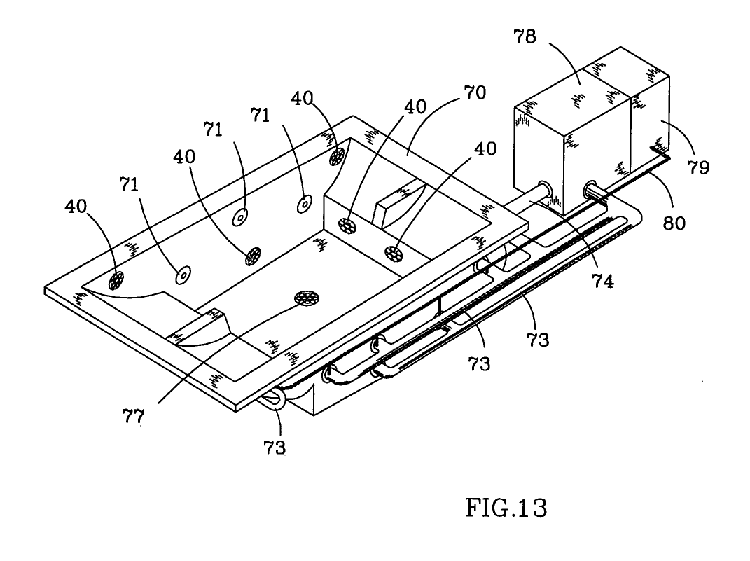

FIG. 12 demonstrates how all the individual parts of double pulsating hydrotherapy jet unit 40 relate to one another, and are assembled. Front flange 42 and gasket 41 combine with locking thread ring 48 to grasp the side of a hydrotherapy spa or tub shell 70 (shown in FIG. 13). Gasket 41 prevents leakage of water from a hydrotherapy spa or tub shell 70. Locking thread ring 48 screws down over exterior threading 43 with interior threading 50. Rotational movement of locking thread ring 48 towards the front of double pulsating hydrotherapy jet unit 40 compresses front flange 42 against gasket 41 and compresses gasket 41 against a wall of hydrotherapy spa or tub shell 70. Gasket 41 is seated behind front flange 42. Housing 44 supports stationery and rotating portions of double pulsating hydrotherapy jet unit 40. This assembly attaches double pulsating hydrotherapy jet unit 40 to the wall of hydrotherapy jet bath.

Mechanical mount retaining ring 60 is placed into Housing 44 to hold outer bearing sleeve 55 in a fixed position. Side wall channel 33 on outer bearing sleeve 55 permits water from water channel 32 to enter the interior of double pulsating hydrotherapy jet unit 40. Discharge member carrier outer sleeve 72 permits attachment to rotating scallop plate 49. Locking feature 61 locks and makes secure the attachment of discharge member carrier 72 to rotating scallop plate 49.

Inner bearing sleeve ridge 62 is used as a stop to prevent bearing rakes 53 and 51 from moving too far forward along inner bearing sleeve 54.

Discharge member 10 slides over and encompasses inner discharge member sleeve 67. Discharge member 10 is held in place by the interlocking of sleeve attachment tab 66 and discharge member attachment slot 14 (shown in FIG. 1). Cap 20 is attached to rotating scallop plate 49. Cap 20 is stationery compared to, and moves with rotating scallop plate 49. Discharge member 10 is mounted at the down stream end of venturi sleeve 30. Venturi sleeve 30 contains aerated water stream 5. Discharge member 10 is designed so impingement by aerated water stream 5 generates a rotational moment causing discharge member 10 to spin about its axis of rotation 11. Located down stream of discharge member 10 is cap 20, which diverts the water flowing from discharge member 10 to produce simultaneous pulsating jets 8 and 9.

As shown in FIG. 13, multiple jets can be installed in a spa or tub shell 70. In this disclosure, spa shell is defined as any bath, pool, reservoir or spa capable of containing a fluid and enabling immersive recreation or therapy. Some or all of the jets can be one of the jets described above, with the jets in this embodiment being jet 40. The remaining jets 71 may be any other desired type, such as a variety of prior single nozzle jets. Both types of jets are connected to a water pump 78, used to circulate the water throughout the spa system, by a series of water conduits 73. Water from shell 70 is provided to pump 78 through the drain 77, which is connected through return water conduit 74 to pump 78. Water from pump 78 is provided back to shell 70 by conduits 73, where it flows into jets 40 and 71, as the case may be, and in turn into shell 70, completing the loop. Additionally, an air system 79 may be included that provides air to individual jets 40 and 71 through an air conduit 80, to aerate the water flowing through the jet. The air system 79 can be pump driven to increase the pressure of the air entering the jet 8, or can be vacuum based with the venturis located within the jets 40 and 71 drawing air into the jets and water flow stream.

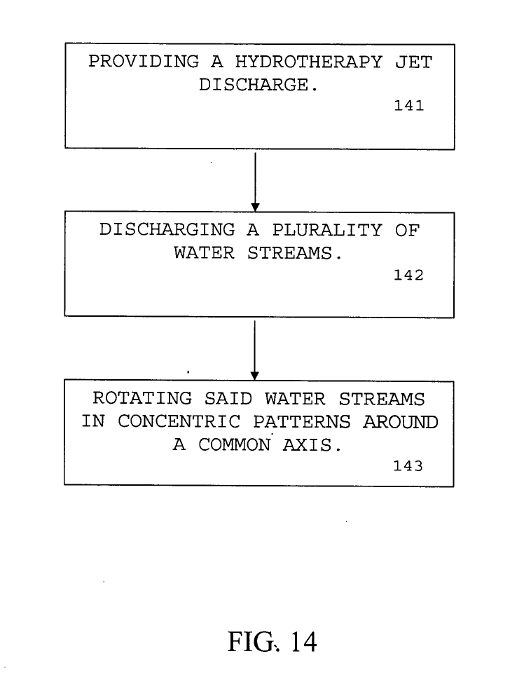

FIG. 14 shows a flow diagram of one embodiment of the claimed invention. A hydrotherapy jet discharge is provided in block 141. A plurality of water streams is discharged in block 142. The water streams are rotated in concentric patterns around a common axis in block 143.

Although the present invention has been described in considerable detail with references to certain preferred configuration thereof, other versions are possible. Therefore, the spirit and scope independent claims should not limited to the preferred version contain therein.

I claim:

1. A pulsating hydrotherapy jet, comprising:
a jet body;
a water inlet to said body;
a water passageway within said body for forming water flowing through said inlet into a water stream; and
a discharge member in said jet body adapted to discharge said water stream as a plurality of subsidiary jets with respective concentric patterns.

2. The hydrotherapy jet of claim 1, further comprising:
a cap mounted on said body to receive said subsidiary jets, said cap having respective pluralities of openings aligned with respective ones of said subsidiary jet patterns to pulse said subsidiary jets when said discharge member is rotated.

3. The hydrotherapy jet of claim 2, wherein said discharge member is rotatably mounted in said body to rotate about an axis in response to a received water stream and discharge said water stream in said plurality of concentric patterns.

4. The hydrotherapy jet of claim 3, wherein said discharge member includes a plurality of conduits that divide the water stream and are oriented so that water flowing through the discharge member imparts a turning moment to said member that causes it to rotate and form said concentric patterns.

5. The hydrotherapy jet of claim 4, wherein said conduits present the appearance of asymmetric bunny ears.

6. The hydrotherapy jet of claim 4, wherein said openings are tapered in the direction of water flow.

7. The hydrotherapy jet of claim 6, wherein said openings intersect to form tapered ridges which divide said water stream between said openings without substantial back flow into said jet body.

8. The hydrotherapy jet of claim 6, wherein respective pluralities of said openings are substantially aligned with each of respective said conduits.

9. The hydrotherapy jet of claim 6, wherein said cap further includes a central opening whose axis is coaxial with that of said cap.

10. The hydrotherapy jet of claim 6, wherein said discharge member conduits have outlets at different distances from said discharge member axis.

11. The hydrotherapy jet of claim 10, wherein one of said conduits is coaxial with said discharge member.

12. The hydrotherapy jet of claim 10, wherein at least one of said conduits is at an offset with an axis that is non-parallel to said discharge member's axis of rotation, said conduit axis being displaced at least 25 degrees in a direction coplanar with said discharge member axis and further displaced at least 6 degrees in a direction normal to said plane.

13. A spa system, comprising:
a spa shell that is capable of holding water;
at least one pulsating hydrotherapy jet mounted around said spa shell;
a water pump system that provides water to said jets;
each of said pulsating hydrotherapy jets, comprising:
a jet body;
a water inlet to said body;
a water passageway within said body for forming water flowing through said inlet into a water stream; and
a discharge member in said jet body adapted to discharge said water stream in a plurality of subsidiary jets with respective concentric patterns.

14. The spa system of claim 13, each of said jets further comprising a cap mounted on said body to receive said subsidiary jets, said cap having respective pluralities of openings aligned with respective ones of said subsidiary jet patterns to pulse said subsidiary jets when said discharge member rotates.

15. The spa system of claim 13, wherein said discharge member is rotatably mounted in said body to rotate about an axis in response to a received water stream and discharge said water stream in said plurality of concentric patterns, and said discharge member includes a plurality of conduits that divide the water stream and are oriented so that water flowing through the discharge member imparts a turning moment to said member that causes it to rotate and form said concentric patterns.

16. The spa system of 15, wherein at least one of said conduits is at an offset with an axis that is non-parallel to said discharge member's axis of rotation, said conduit axis being displaced at least 25 degrees in a direction coplanar with said discharge member axis and further displaced at least 6 degrees in a direction normal to said plane.

17. A pulsating hydrotherapy jet, comprising:
a cap formed with multiple spaced openings that are positioned at a plurality of distances from the center of said cap; and
a discharge member rotatably mounted about a rotation axis upstream of the cap, said member having a plurality of conduits that are oriented at an angle to said rotation axis;
said member dividing water flowing through said jet into a plurality of water streams that flow through said conduits and cause said member to rotate and discharge said water streams in a plurality of concentric flows, through said spaced openings, thereby producing a plurality of pulsating jets.

18. The hydrotherapy jet of claim 17, wherein at least one of said conduits is at an offset with an axis that is non-parallel to said discharge member's axis of rotation, said conduit axis being displaced at least 25 degrees in a direction coplanar with said discharge member axis and further displaced at least 6 degrees in a direction normal to said plane.

19. A method of providing a hydrotherapy jet discharge, comprising:
discharging a plurality of water streams, and
rotating said water streams in concentric patterns around a common axis.

20. The method of claim 19 further comprising periodically interrupting said water streams to produce a pulsed jet discharge.

21. The method of claim 19 further comprising discharging said plurality of water streams in concentric patterns having different radii around said axis.
